(19) United States
(12) Patent Application Publication
(10) Pub. No.: US 2009/0290940 A1
(43) Pub. Date: Nov. 26, 2009

(54) APPARATUS AND METHOD FOR USING MULTIPLE TOOLS ON A SINGLE PLATFORM

(76) Inventor: John Paul Martin, SR., Hillsboro, OR (US)

Correspondence Address: STOEL RIVES LLP - PDX, 900 SW FIFTH AVENUE, SUITE 2600, PORTLAND, OR, 97204-1268, US

(21) Appl. No.: 12/470,257

(22) Filed: May 21, 2009

Related U.S. Application Data
(60) Provisional application No. 61/055,103, filed on May 21, 2008.

(51) Int. Cl. E02D 7/00; A01B 49/04; E02D 7/10

(52) U.S. Cl. 405/232; 172/136

(57) ABSTRACT

A soil structure tool for building structures in soil, placing structures in soil, or both, may improve the load bearing capability for soil by using multiple devices as part of a single tool. The soil structure tool may be operated to place a first device in a working position while placing the remaining device or devices in a non-working position so the first device in the working position may be used without interference from the remaining tools. Moving devices attached to the soil structure tool between the working and non-working positions permits building structures in soil or placing structures in soil without requiring multiple vehicles or other platforms to hold various devices and without requiring multiple devices to be attached to or detached from a vehicle or other platform.

### RELATED APPLICATIONS

This application claims priority under 35 U.S.C. §119(e) to U.S. Provisional Application No. 61/055,103 titled Apparatus and Method for Using Multiple Tools on a Single Platform and filed on May 21, 2008, which is fully incorporated by reference herein.

### TECHNICAL FIELD

The field of the present invention relates to an apparatus and method for using multiple devices on a single platform to build or place structures in soil.

### BACKGROUND

Civil engineering and building construction frequently require improving soil structure, operations involving placing items into the ground, or both. For example, it may be desired to install a concrete column in the soil to support a structure on the surface of the soil. Current apparatuses may use a first tool, such as a vibratory pile driver, to insert a casing pipe into the ground. Once the first tool is removed from the apparatus, a second tool, such as a drill or auger, is connected to the apparatus for drilling out the soil within the casing. Alternatively, current civil engineering and building construction practices may use two apparatuses, each carrying one tool. The first apparatus is moved into place to insert a casing into the soil, then the first apparatus is removed from the location. The second apparatus is moved to the location, aligned with the casing in the ground, and used to drill out the soil within the casing.

Another example is when soil is not sufficiently strong to resist settling underneath a structure. Current civil engineering and building construction practices may construct a deep foundation system or a relatively shallow aggregate pier to improve the soil structure. Deep foundation systems, such as piles or drilled piers that extend to rock or stronger soils to support a structure, tend to be rather expensive compared to shallow foundations. Deep foundation systems were once required where the near-surface soils included soft to stiff clays, silts, sandy silts, loose to firm silty sands and sands. Recent developments for relatively shallow foundations decrease the amount of settlement (influenced by the soil's compressibility) that occurs underneath a structure by reinforcing the in-situ soils using short aggregate piers. Short aggregate piers allow shallow foundations to be used in place of deep foundations or smaller footings to be used in circumstances where space limitations are critical. In either instance, a substantial cost savings can be realized using short aggregate piers to reinforce the near-surface soils.

One known method for producing aggregate piers used to reinforce soil requires using two separate tools, often attached to two separate large, earthmoving vehicles such as excavators. A second known method uses specialized equipment that requires consumable components.

With the first method, a bore, or cavity, is made in the soil by drilling with an auger or using another earth boring tool. The bore typically ranges from seven to thirty feet in depth, although other depths may be used, and may range from a few inches in diameter up to sixteen inches in diameter. Once the bore has been drilled, the excavator, or other earth moving vehicle, moves away from the bore so a second earth moving vehicle may install the aggregate pier using a tamping tool.

The tamping tool, which may be connected to a vibratory impact head, pneumatic hammer, or other force imparting device, may be lowered into the bore and used to compact the soil at the bottom of the bore. Layers of aggregate are then introduced into the bore in lifts that typically range from a few inches to about three feet. The tamping tool compacts each lift of aggregate using vertical impact ramming energy. The tamping tool increases the density of the aggregate in the vertical direction and forces aggregate laterally into cavity sidewalls. The result is a “pillow” of compacted aggregate that pre-stresses the soil laterally proximate the aggregate lift. The process of adding a lift and compacting the lift with the tamping tool is repeated to build a pier of successive aggregate “pillows” on top of one another. Such aggregate piers mechanically couple with the surrounding soil and provide reliable settlement control. To create a second aggregate pier, the vehicle with the tamping tool is moved away and the vehicle with the boring tool is moved into position, and the process is repeated. Alternatively, the boring tool may be detached from a vehicle and replaced with the tamping tool instead of using two vehicles each equipped with one tool.

The second method for producing aggregate piers uses a specially designed mandrel. A bore is created by driving the specially designed mandrel to a depth typically ranging from seven to thirty-five feet. The mandrel, which also has a tamper foot, is driven using a relatively large static force augmented by dynamic vertical impact energy, for example from a pneumatic hammer. A sacrificial cap prevents soil from entering the tamper foot and mandrel.

After driving to the design depth, the hollow mandrel serves as a conduit for placing aggregate. The aggregate is placed inside the mandrel and the mandrel is lifted, leaving the sacrificial cap at the bottom of the pier. The tamper foot is lifted approximately three feet and then driven back down two feet, forming a one-foot thick compacted lift, and a “pillow” as described above. Compaction is achieved through static force and dynamic impact energy from the hammer. Compaction increases the density of the aggregate vertically and the beveled tamper foot forces aggregate laterally into cavity sidewalls. The process of placing aggregate and compacting it is repeated until an aggregate pier of successive “pillows” on top of one another is built.

### SUMMARY

The inventor has recognized that current apparatuses and methods for improving soil structure and placing items in the ground have certain disadvantages. For example, the inventor has recognized that the casing and drilling and the drilling and tamping methods described above require either two earth moving vehicles, or other tool platforms, or changing tools on one vehicle, or tool platform, between casing and drilling operations and between drilling and tamping operations. Using two separate earth moving vehicles is time consuming and expensive, and changing tools between operations is even more time consuming. The inventor has also recognized that the specialized mandrel with a tamper foot requires a supply of sacrificial caps at a job site to create more than one aggregate pier.

To solve the above, or other problems, a soil structure tool may be used for building structures in soil or for placing structures in the ground as well as other applications. An exemplary soil structure tool is attached to a single vehicle, or other tool platform, and permits the one vehicle, or other tool platform, to perform multiple operations without removing and attaching tools to the tool platform. For example, the exemplary soil structure tool both creates a bore in the soil and builds an aggregate pier in the bore without moving the tool platform from its location. A first tool arm bears an auger or other digging device for creating a bore in the soil. A second tool arm bears an impacting device operably connected to a tamping tool. Moving an arm or actuating driving devices, or both, moves the soil structure tool between a working position for the digging device and a working position for the impacting device. In other embodiments the digging device, or other tool, and the impacting device, or other tool, are carried on a rotating platform that rotates between a working position for the digging device, or other tool, and a working position for the impacting device, or other tool. Other embodiments may use different devices or systems for moving between a working position for a first tool and a working position for a second tool.

Additional aspects and advantages will be apparent from the following detailed description of preferred embodiments, which proceeds with reference to the accompanying drawings.

### BRIEF DESCRIPTION OF THE DRAWINGS

FIG. 1 is an illustration of a vehicle equipped with a soil structure tool in the working position for a digging device and the non-working position for an impacting device.

FIG. 1A is a side view of an exemplary tool head.

FIG. 1B is a side view of another exemplary tool head.

FIG. 2 is an illustration of a vehicle equipped with a soil structure tool in the working position for an impacting device and the non-working position for a digging device.

FIG. 2A is a detail view of a portion of a soil structure tool.

FIGS. 3 to 5 are illustrations of steps for creating aggregate piers in-situ in the soil.

FIG. 6 is a side sectional illustration of an aggregate pier in-situ in the soil and supporting a portion of a structure.

FIG. 7 is an illustration of a vehicle equipped with a soil structure tool in the working position for a vibrational pile driver and the non-working position for an auger.

FIG. 8 is an illustration of a vehicle equipped with a soil structure tool in the working position for an auger and the non-working position for a vibrational pile driver.

FIG. 9 is an illustration of a vehicle equipped with a rotatable soil structure tool in the working position for a first tool and the non-working position for a second tool.

FIG. 10 is an illustration of a vehicle equipped with the rotatable soil structure tool of FIG. 9 in the working position for a second tool and the non-working position for a first tool.

FIG. 11 is an illustration of a vehicle equipped with a soil structure tool having a first tool and a second tool rotatably connected to a tool head with the first tool in a working position and the second tool in a non-working position.

FIG. 12 is an illustration of a vehicle equipped with the soil structure tool of FIG. 11 having a first tool and a second tool rotatably connected to a tool head with the second tool in a working position and the first tool in a non-working position.

### DETAILED DESCRIPTION OF PREFERRED EMBODIMENTS

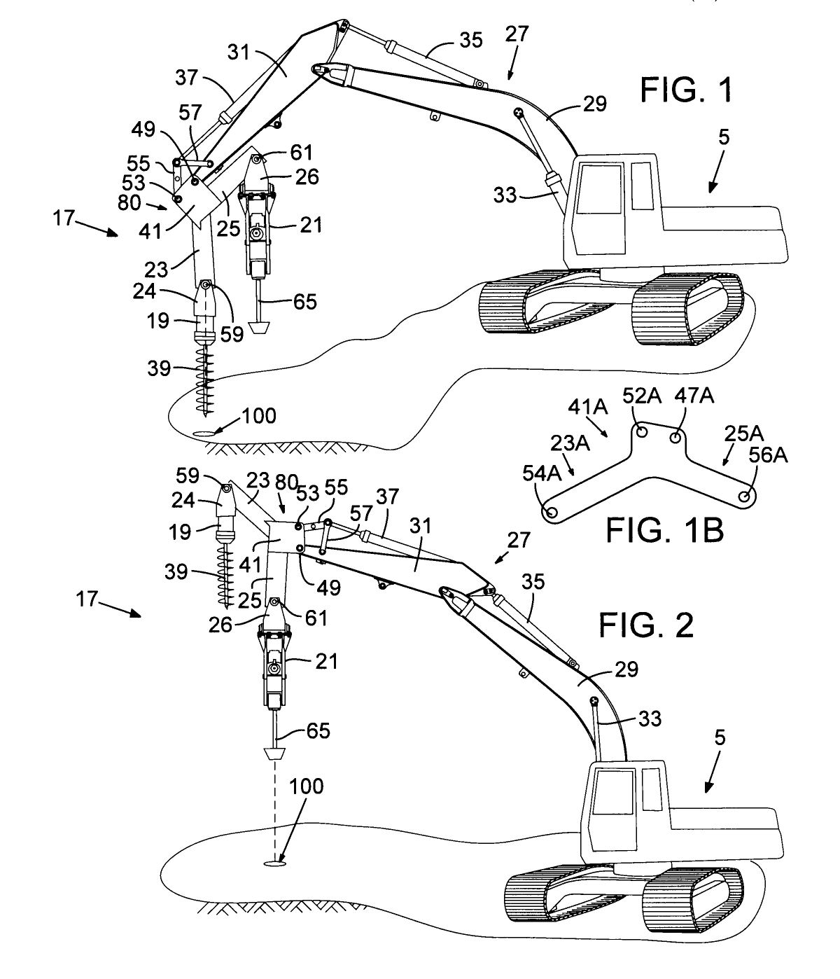

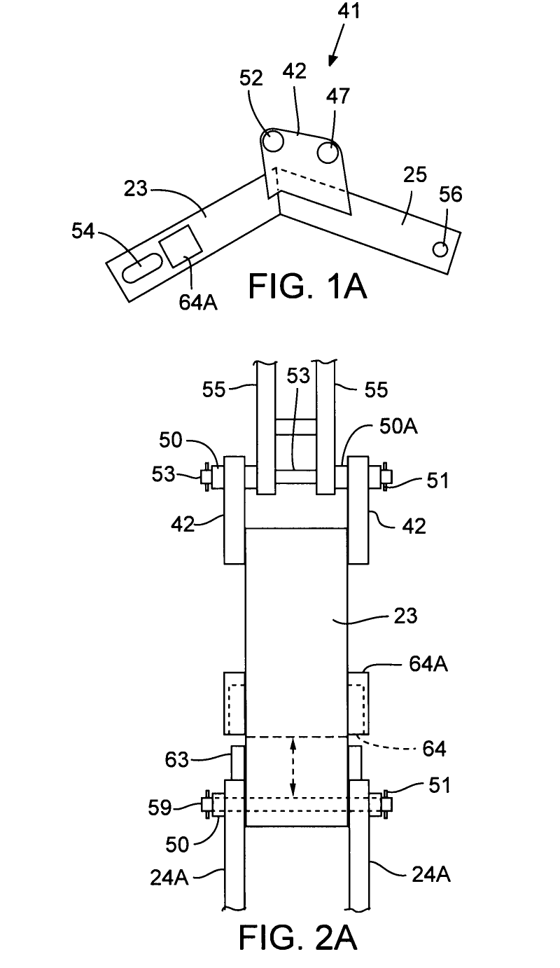

Referring now in detail to the drawings, in which like reference numerals represent like parts throughout the several views, FIGS. 1-2A depict embodiments having a tool platform 15 equipped with a soil structure tool 17. A soil structure tool 17 may be mounted on a variety of tool platforms other than vehicles, and the tool platforms 15 may be mobile or stationary. With reference to FIGS. 1-6, embodiments of soil structure tools, such as soil structure tool 17, are described with a first device, such as digging device 19, and a second device, such as impacting device 21, attached to a tool head, such as tool head 41, for building an aggregate pier. But, soil structure tools may be used for any number of applications and may have devices other than the digging device 19 and the impacting device 21 attached to a first tool arm 23 and a second tool arm 25 as described below.

Tool platform 15, depicted as an excavator, has an articulating arm 27 comprising a boom 29 and a dipper arm 31. The boom 29 is connected to the tool platform 15 so that the boom 29 rotates with respect to the tool platform 15 in a vertical plane. A first hydraulic cylinder 33 expands and contracts to raise and lower the boom 29. The dipper arm 31 is pivotally connected to the boom 29 at or near the distal end of boom 29 for rotation about pivot 30 in substantially the same vertical plane as boom 29 and is driven by a second hydraulic cylinder 35. The soil structure tool 17 is pivotally connected to the dipper arm 31 and is driven by a third hydraulic cylinder 37. Preferred tool platforms 15 include earth moving equipment, such as excavators and loaders, cranes, derricks, a truck with an articulated arm, cherry pickers, and other suitable platforms.

FIG. 1 illustrates the soil structure tool 17 pivoted to a working position for the digging device 19. The digging device 19 preferably includes an electric, pneumatic, hydraulic, gasoline, or other suitable motor with an auger 39 attached to it. Other suitable digging devices for creating a bore in the ground may be used, and do not need to create cylindrical bores. The auger 39 is depicted with one relative size, but may have a longer or shorter shaft, or larger or smaller diameter blades, than those features depicted in FIGS. 1 and 2. The digging device 19 is placed in a working position by operating the first hydraulic cylinder 33 to move the boom 29 to a position substantially parallel to the ground. The second hydraulic cylinder 35 is operated to pivot the dipper arm 31 to move the soil structure tool 17 closer to the ground. Third hydraulic cylinder 37 is operated to pivot the soil structure tool 17 so that gravitational force moves the first tool arm 23 and the digging device 19 into a substantially vertical and substantially linear relationship.

In one embodiment, the first tool arm 23 and the second tool arm 25 are rigidly attached portions of the tool head 41 and do not pivot with respect to the tool head 41. But, the digging device 19 is preferably pivotally connected to the first tool arm 23 and the impacting device 21 is preferably pivotally connected to the second tool arm 25. In another embodiment (not shown), the first tool arm 23 and the second tool arm 25 are pivotally attached to the tool head 41, preferably at spaced apart pivot points. In another alternate embodiment illustrated in FIG. 1B, the tool head 41A is preferably made as a unitary piece and includes a first elongate portion 23A and a second elongate portion 25A. First elongate portion 23A and second elongate portion 25A preferably extend substantially away from each other to keep tools (not illustrated) sufficiently separated from each other. The first and second elongate portions 23A and 25A do not need to be shaped as illustrated. For example, tool head 41A may be in the shape of a trapezoid, triangle, or other suitable shape. Tool head 41A may be formed as a metal casting or forging, by machining one or more solid plates or blocks of material into an appropriate shape, or by other suitable manner.

The tool head 41 preferably includes two flat generally rectangular plates made from a rigid material such as steel. Alternately, the tool head 41 may include a carriage that is cast, machined, welded, or bolted together. The first tool arm 23 and the second tool arm 25 are preferably steel tubing having a square cross section, and are preferably in a range of 55 to 65 inches long. The first tool arm 23 and the second tool arm 25 have mating ends 60, shown in partially dashed lines under plate 42, respectively, that are preferably cut to create an obtuse angle between the first tool arm 23 and the second tool arm 25 when the ends are matched together (FIG. 1A). For example, in a preferred embodiment the angle between the first tool arm 23 and the second tool arm 25 is approximately 131 degrees. The first tool arm 23 and the second tool arm 25 are preferably rigidly attached at their mating ends, by welding for example. The length of the tool arms and the angle between the tool arms may be adjusted outside the ranges disclosed herein to mount tools sufficiently distant to permit operation of one tool without interference from the other. The types of tools being mounted may also affect the length of tool arms and the angle between them.

Referring to FIG. 1, a preferred tool head 41 is formed by welding the first tool arm 23 and the second tool arm 25 to a tool head base 80. The tool head base 80 is preferably constructed from two flat generally rectangular plates 42 (only one shown), and has a portion of each flat generally rectangular plate 42 protruding away from the mating ends, such as mating ends 60 (FIG. 1A), of the first tool arm 23 and the second tool arm 25. Alternately, the tool head base 80 may be constructed from a solid piece of material, or from multiple plates, rods, or other suitable structure. The plates 42 preferably extend over the mating ends of the arms 23 and 25 as illustrated in FIG. 1. But, the plates may have various shapes and sizes, for example as illustrated in FIG. 1A.

Two apertures 47 (only one shown) in each of the flat generally rectangular plates 42 generally distal from the first tool arm 23 and the second tool arm 25 are provided for pivotally mounting the tool head 41 to the tool platform 15. For example, the two apertures 47, one in each of the flat generally rectangular plates, are preferably proximate the second tool arm 25 and are used for pivotally mounting the soil structure tool 17 to the dipper arm 31 by passing a first pin 49 (FIG. 1) through the apertures 47 and a pivot mount aperture (not labeled) on the dipper arm 31. The first pin 49 is preferably held in place by collars, such as collars 50 (FIG. 2A), on each end of the pin 47, with or without washers, such as washers 50A (FIG. 2A), and secured by cotter keys, such as cotter keys 51 (FIG. 2A). However, other means for holding the pin 49 in place may be used, such as retaining clips, threading the end of the pin 49 and using a threaded nut, or other suitable means.

A second set of apertures 52 (only one shown), one in each of the flat generally rectangular plates 42, proximate the first tool arm 23 are preferably used for pivotally connecting the tool head 41 to the third hydraulic cylinder 37. For example, by passing a second pin 53 (FIG. 2A) through the apertures 52 and a rod 55 (FIG. 2A) connected to the third hydraulic cylinder 37. The second pin 53 is held in place as described above with respect to the first pin 49. A linkage arm 57 (FIG. 1) is preferably pivotally connected to the dipper arm 31 and to the rod 55 to assist pivotal movement of the tool head 41.

In one configuration, the soil structure tool 17 includes a digging device 19 pivotally connected proximate a free end of the first tool arm 23, that is, an end of the tool arm 23 located distal from the centroid of the tool head 41. For example, a device mount, that is, an apparatus configured at one end to attach to a tool head, such as tool head 41, and also configured to retain a soil modifying device, such as digging device 19, is preferably pivotally attached to the first tool arm 23, thereby pivotally connecting a soil modifying device to a tool head, such as tool head 41. The first device mount 24 is preferably pivotally connected to the first tool arm 23 by a third pin 59 (FIG. 1) passing through apertures 54 in the end of the first tool arm 23. Using a device mount, such as device mount 24, to attach soil modifying devices preferably permits various devices to be attached to a soil structure tool without modifying the devices. In other words, various device mounts may be custom made to attach existing soil modifying devices to a tool head without modifying the existing soil modifying devices.

The first device mount 24 preferably includes two steel plates 24A shaped and sized to grip, hold, or attach to a device, such as digging device 19. However, a device mount may include a carriage that is cast, machined, welded, or bolted together; or other suitable structure, for retaining a device and connecting a device to a tool head, such as tool head 41. The first device mount 24 preferably has one plate 24A located on either side of the first tool arm 23 and pinned to the tool arm 23 as described above. The soil structure tool preferably also includes an impacting device 21 pivotally connected to the second tool arm 25 in a similar manner. For example, a second device mount 26 is preferably pivotally connected to the second tool arm 25 by a fourth pin 61 passing through apertures 56 in the end of the second tool arm 25. The second device mount 26 preferably includes two steel plates, one located on either side of the second tool arm 25, shaped and sized to grip, hold or attach to a device, such as impacting device 21. The third and fourth pins 59 and 61 may be held in place by any means, including collars on each end of the pin secured by cotter keys.

Device mounts, such as device mounts 24 and 26, grip or hold a device, such as devices 19 and 21, and connect to a tool head, such as tool head 41. Devices are connected to device mounts, either directly or via an intervening structure, by bolting, welding, interlocking structure, such as threads or a bayonet connection, or other suitable connection. Device mounts, such as device mounts 24 and 26, are preferably detachably connected to a tool head, such as tool head 41, for example, via pins held in place by collars and cotter keys. Detachable connections preferably facilitate rapidly removing and attaching devices should a soil structure tool, such as soil structure tool 17, require a change in the devices, for example, for maintenance or to construct a different structure.

In other embodiments, a pivot stop (not depicted) may prevent or limit the second tool arm 25, or the second device mount 26 and impacting device 21 combination, or both, from pivoting when the soil structure tool 17 is in a working position for the digging device 19. Likewise, a pivot stop (not depicted) may prevent or limit the first tool arm 23, or the first device mount 24 and digging device 19 combination, or both, from pivoting when the soil structure tool 17 is in a working position for the impacting device 21.

In one embodiment, the first device mount 24 and digging device 19 combination are preferably attached to the first tool arm 23 in both a pivotal manner and in a manner that allows relative displacement between the first tool arm 23 and the digging device 19, for example, by using a elongate apertures 54 in the first tool arm 23 to receive pin 59. As illustrated in FIG. 1, the articulating arm 27 is operated to position the digging device 19 into a substantially aligned position with the longitudinal axis of the first tool arm 23. Preferably, the force of gravity acting on the digging device 19 moves the digging device 19 into a substantially aligned position with the longitudinal axis of the first tool arm 23. However, mechanical, electrical, hydraulic, pneumatic, or other suitable actuators may be provided to substantially align the digging device 19 with the longitudinal axis of the first tool arm 23.

If the first device mount 24 is attached to the first tool arm 23 in both a pivotal manner and in a manner that allows relative displacement between the first tool arm 23 and the first device mount 24, such as illustrated in FIG. 2A, when the first tool arm 23 and the first device mount 24 are in a substantially linear and substantially vertical relationship as depicted in FIG. 1, lowering the boom 29 (by operating the articulating arm 27) causes the tip of the auger 39 to contact the ground. Continued relative movement between the articulating arm 27 and the soil structure tool 17 causes the first tool arm 23 to move towards the first device mount 24, which is held in place by the auger 39 contacting the ground. A selectively engagable coupling structure arranged between the first tool arm 23 and the first device mount 24 preferably “locks” the first device mount 24 into a non-pivotal position with respect to the tool arm 23. Suitable coupling structures include, but are not limited to, shaft collars, buckles, ring clamps, flanged shafts, keyed sleeves, friction clip shafts, plain sleeves, and multi-jaw couplings.

An exemplary coupling structure, which may be described as a modified multi-jaw coupling, includes a tongue 63 (FIG. 2A) preferably attached to or formed as part of the first device mount 24. A groove 64 (FIG. 2A), for example formed in a block 64A (FIGS. 1A and 2A) is preferably attached to or formed as part of the first tool arm 23. The tongue 63 aligns with the groove 64 when the longitudinal axis of the tool arm 23 substantially aligns with a longitudinal axis extending thorough a soil modifying device held by the device mount 24. The groove 64 may be flared or widened at its opening to assist inserting the tongue 63 therein. The tongue 64 and groove 63 are preferably located proximate a centerline of a face of the tool arm 23, but may be mounted off-center in alternate embodiments.

When the first device mount 24 is in a substantially linear relationship with the first tool arm 23 and moves towards the first tool arm 23, the first tool arm 23 and the first device mount 24 engage by interacting the tongue 63 with the groove 64, thus preventing pivotal movement between the first tool arm 23 and the digging device 19 retained by the first device mount 24. Preventing pivotal movement between the first tool arm 23 and the digging device 19 preferably prevents the first tool arm 23 and the digging device 19 from becoming misaligned when the digging device 19 is operated to bore a hole in the soil with the auger 39.

By actuating the hydraulic cylinders 33, 35, and, 37 the articulating arm 27 may be lowered while the soil structure tool 17 is pivoted relative to the dipper arm 31 to push the auger 39 deeper into the ground. For example, hydraulic cylinders 33 and 35 are operated to move the articulating arm 27. If the hydraulic cylinder 37 is not operated when hydraulic cylinders 33 and 35 are operated, the auger 39 will be pushed into a differing angular relationship with respect to the bore 100. Operating hydraulic cylinder 37 to pivot the soil structure tool 17 when the articulating arm 27 is moved therefore maintains the angular relationship of the auger 39 with respect to the bore 100 and thus advance the auger 39 along the axis of bore 100.

Once a bore 100 has been created to the desired depth, the articulating arm 27 is raised to remove the auger 39 from the bore 100. If there is a coupling structure engaging the first tool arm 23 and the first device mount 24, the upward movement of the articulating arm 27 combined with the weight of the digging device 19 and the auger 39 preferably causes the coupling structure to disengage, thus allowing the first device mount 24 to pivot with respect to the first tool arm 23.

Referring to FIG. 2, the soil structure tool 17 is pivoted to a working position for the impacting device 21. For example, the impacting device 21 may be a vibratory pile driver, pneumatic hammer, hydraulic hammer, or other suitable device for creating an impact force. The impacting device 21 is preferably operably connected to a tamper apparatus 65. The tamper apparatus 65 is depicted with one relative size, but may have a longer or shorter shaft, or a different tamping head, than those features depicted in FIGS. 1 and 2.

The impacting device 21 is preferably placed in a working position by operating the first hydraulic cylinder 33 to move the boom 29 to a position substantially above a parallel position with respect to the ground. The second hydraulic cylinder 35 is preferably operated to pivot the dipper arm 31 to a position substantially parallel with respect to the ground. Third hydraulic cylinder 37 is preferably contracted to pivot the soil structure tool 17 so that gravitational force pulls the second tool arm 25 and the impacting device 21 into a substantially vertical and substantially linear relationship as illustrated in FIG. 2.

The impacting device 21 is retained by the second device mount 26, which is attached to the second tool arm 25 in both a pivotal manner and in a manner that allows relative displacement between the second tool arm 25 and the second device mount 26 as described above. For example, when the second tool arm 25 and the second device mount 26 are in a substantially linear and substantially vertical relationship as depicted in FIG. 2, lowering the boom 29 causes the tip of the tamper apparatus 65 to contact the ground at the bottom of the bore 100, or to contact aggregate placed in the bore 100. Relative movement between the articulating arm 27 and the soil structure tool 17 preferably causes the second tool arm 25 to move towards the second device mount 26, which is held in place by the tamper apparatus 65 contacting the ground or aggregate. A coupling structure preferably engages to prevent pivotal movement between the second tool arm 25 and the second device mount 26, and thus between the second tool arm 25 and the impacting device 21. Preventing pivotal movement between the second tool arm 25 and the impacting device 21 may prevent the second tool arm 25 and the impacting device 21 from becoming misaligned when the impacting device 21 is operated to compact soil at the bottom of the bore 100 or to compact aggregate in the bore 100.

By actuating the hydraulic cylinders 33, 35, and, 37 the articulating arm 27 is lowered while the soil structure tool 17 is pivoted, such as described above.

Once an aggregate pier has been built, as described below, the articulating arm 27 is raised to remove the tamper apparatus 65 from the bore 100. If there is a coupling structure engaging the second tool arm 25 and the second device mount 26, the upward movement of the articulating arm 27 combined with the weight of the impacting device 21 and the tamper apparatus 65 preferably causes the coupling structure to disengage, thus allowing the second device mount 26 to pivot with respect to the second tool arm 25.

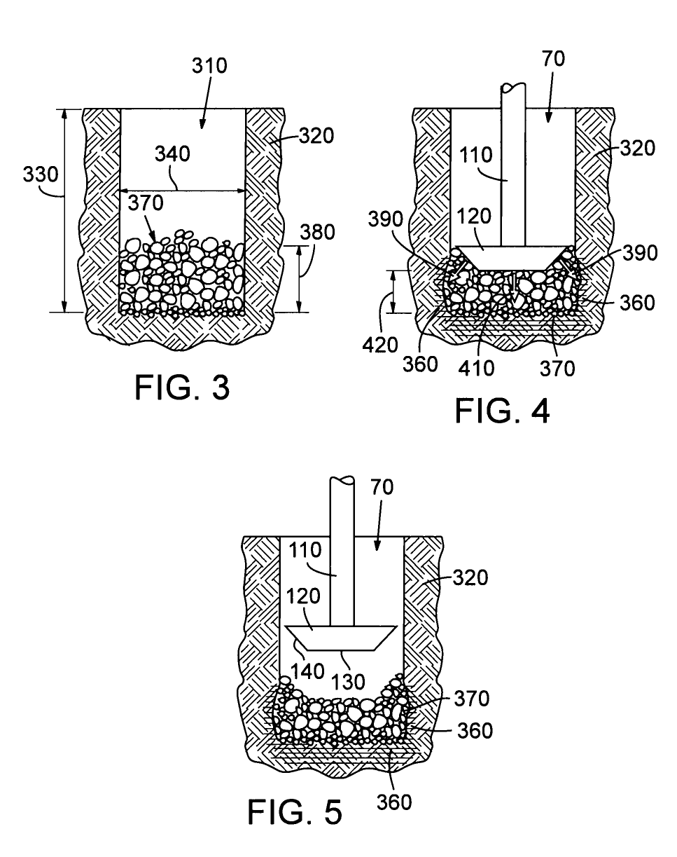

FIGS. 3-5 depict a method for constructing aggregate piers using soil structure tool 17. As described above, the soil structure tool 17 is pivoted to place the digging device 19 in a working position (FIG. 1) while simultaneously placing the impacting device 21 in a non-working position. A bore 310 is then created by operating the articulating arm 27 and using the digging device 19. The digging device 19 is lifted from the bore 310 and the soil structure tool 17 is pivoted to place the impacting device 21 in a working position (FIG. 2) while simultaneously placing the digging device 19 in a non-working position. As shown in FIGS. 4 and 5, the tamper apparatus 65 includes an elongated support shaft 110 and a tamping head 120, however, other tamping apparatuses may be used, such as a solid structure having a relatively uniform cross section, a hollow structure having a relatively uniform cross section, a shaft with a different shaped head, such as a conical or flat head, or other suitable apparatus. The tamper apparatus 65 is driven downwardly as described above.

The tamping head 120 preferably includes a generally flat, blunt bottom face indicated as 130 and a tapered surface indicated as 140. The flat bottom face 130 is adapted for compacting soil and aggregate fill in a vertical direction, while the tapered surface 140 is frusto-conical for tamping soil at a 45 degree angle, or other suitable angle, with respect to a vertical axis extending through the support shaft 110. Alternative tamper apparatuses may be used, and the shape of a tamper apparatus may be specifically designed for a particular task. For example, in addition to a flat bottom surface 130 and a frusto-conical surface 140, a tamper apparatus may have a spherical or near-spherical bottom surface, or other shape.

FIG. 3 shows a bore 310 formed in an existing soil 320. The bore 310 is excavated to a depth 330 and to a diameter 340. The depth 330 and the diameter 340 of the bore 310 may correlate to the nominal dimensions of the aggregate pier to be constructed, although the depth 330 may be increased by 12 inches or more by vertical compaction of the soil at the bottom of the bore 310 prior to placing the first layer of aggregate fill. The bore 310 is discussed as having a round cross-section and, therefore, having a diameter. However, other shapes can be constructed as the particular application requires.

With the soil structure tool 17 pivoted to place the impacting device 21 in a working position above the bore 310, the next step may be to compact the soil at the bottom of the bore 310 to increase the density of the soil directly beneath the bottom of the bore 310. Compacting the soil at the bottom of the bore 310 may be beneficial and increase the support capacity of the aggregate pier. The result may be an improved soil column of prestressed and increased density soil 360 adjacent and beneath the bottom of the bore 310. The apparatuses and methods described in co-pending U.S. Patent Application No. 61/061,965 may be used to create improved soil columns, for example, by increasing the density of the soil beneath the bottom of the bore 310. In some embodiments, the method stops after compacting the soil at the bottom of the bore. Other embodiments do not include the step of compacting the soil at the bottom of the bore 310.

The next step is preferably filling a portion of the bore 310 with a quantity of loose aggregate, preferably well-graded aggregate, generally indicated as 370 in FIG. 3. Other granular material besides loose aggregate may be used and may depend on the particular application for the aggregate pier. Well-graded aggregate is preferred because substantial strength may be imparted by the larger particles in the well-graded aggregate, and the smaller particles may act to fill the interstices between the larger particles. The aggregate 370 is added to a depth 380 to create an uncompacted layer. The depth 380 preferably is eighteen inches, but may be between three inches and three feet.

With a layer of aggregate 370 partially filling a bottom portion of the bore 310, the next step is to compact the aggregate with the tamping apparatus 70 to increase the density of the aggregate and to induce lateral stresses in the soil laterally surrounding the bore 310 in the vicinity of the layer of aggregate 370. These lateral stresses may prestress the lateral soil in the vicinity of the layer of aggregate 370, and may simultaneously increase the soil's density. As shown in FIG. 4, the forces exerted on the aggregate 370, and thereby on the surrounding soil, tamped by the tamping apparatus 70 tend to be normal to the surfaces of the tamping apparatus 70. Thus, the forces exerted by the flat bottom portion 130 may tend to compress the aggregate 370 primarily vertically. The forces from the frusto-conically tapered surface 140 preferably have both a vertical and a lateral force component on the aggregate 370. Since the frusto-conical surface 140 is at an approximate 45 degree angle with respect to a vertical axis, which axis is substantially co-incident with the axis of travel of the tamper apparatus 65, the magnitude of the lateral component of forces exerted on the aggregate 370 by the conically-tapered surface 140 may be equal to the magnitude of the vertical component of the force exerted on the aggregate 370. The resultant lateral and vertical force components exerted on the aggregate 370 by the conically-tapered surface 140 is depicted in FIG. 4 by force arrows 390. Force arrows 410 depict the vertical forces exerted by the bottom surface 130 acting on the aggregate 370. By operating the tamping apparatus 70, the height 380 of the aggregate layer 370 is reduced. For example, the uncompacted layer of aggregate 370 may have an initial height of eighteen inches before compaction, and after compaction may have a height 420 that is approximately one-third, or less, of the uncompacted height 380.

Because the aggregate layer 370 is preferably made up of a large number of granular elements that are able to move relative to each other, the downward force 410 exerted by the bottom surface 130 of the tamping apparatus 70 preferably causes outward pressure on the sidewalls of the bore 310. Outward pressure on the sidewalls of the bore 310 may be augmented by the horizontal force components 390 from the tapered surface 140 acting on the aggregate layer 370. In some embodiments the aggregate 370 bulges beyond the original sidewalls of the bore 310 as indicated schematically in FIGS. 4 and 5. The lateral force component 390 may also cause prestress in the soil 320 in the vicinity of the now-compacted aggregate layer 370.

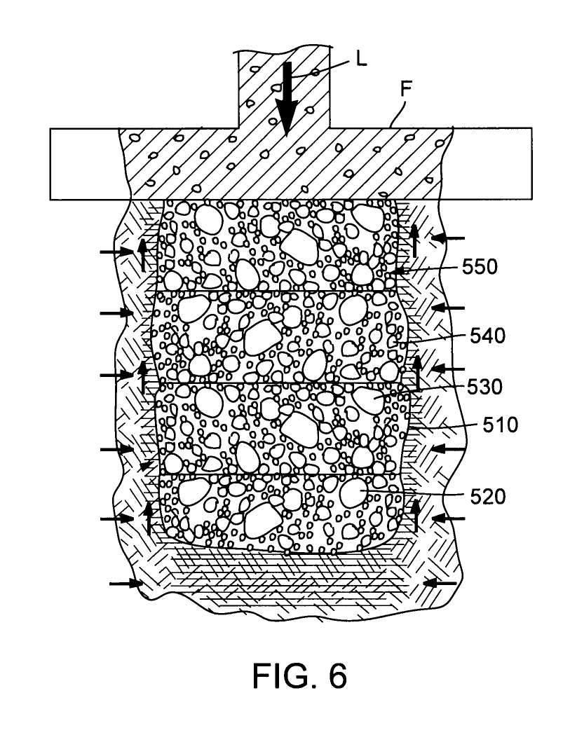

The tamping apparatus 70 is then withdrawn from the bore 310 by operating the articulating arm 27, and an additional layer of uncompacted, loose aggregate is added atop the compacted layer to an additional depth of, for example, eighteen inches. The new layer of loose aggregate is then similarly compacted to a reduced height of, for example, twelve inches. This process is repeated until a series of bulged layers extends from the bottom of the bore 310 and fills the cavity as shown in FIG. 6, or fills the bore 310 to an extent desired.

As shown in FIG. 6, the aggregate pier 510 may be generally cylindrical in overall shape, but have a series of bulges, or “pillows,” extending along its length. Aggregate pier 510, for example, comprises first, second, third and fourth lifts or layers 520-550. Each layer may have a generally bulged shape. The resulting external surface of compacted aggregate may have a greater surface area than a conventional deep stone column of the same nominal diameter. Also, by virtue of the construction of these bulges during compaction of the aggregate pier 510, the surrounding soil may be prestressed and have an increased density in the zone laterally adjacent the aggregate pier 510. FIG. 6 also shows that the aggregate pier 510 can be used to support a footer F for bearing the load of a building structure indicated by the force arrow labeled L.

The soil structure tool 17 may be used in various manners, for example, but not limited to, improving soil to support various structures by building aggregate piers, conducting dynamic subgrade improvement, or by placing items into the ground. Larger, deeper bores may be spaced apart, or placed proximal to one another, and may be used to build aggregate piers for supporting buildings or other relatively heavy structures. In some embodiments, the soil improvement tool 40 may be used to improve soil to support a structure with a relatively spread-out load, such as a railway or layer of pavement. Improved soil columns, or bores may be made in a grid pattern and may have, for example, a diameter of two inches and a depth of six inches. Aggregate piers may be built inside the bores. Spacing between the improved soil columns or bores may be approximately four times the diameter but may vary from as low as two times the diameter to as great six times the diameter. Preferably, the grid includes sixty-four improved soil columns or bores, but may contain as few as four. The resulting grid of small-scale improved soil columns or aggregate piers may increase the load-bearing capability of the soil, making it suitable for supporting a road, runway, railroad or other structure.

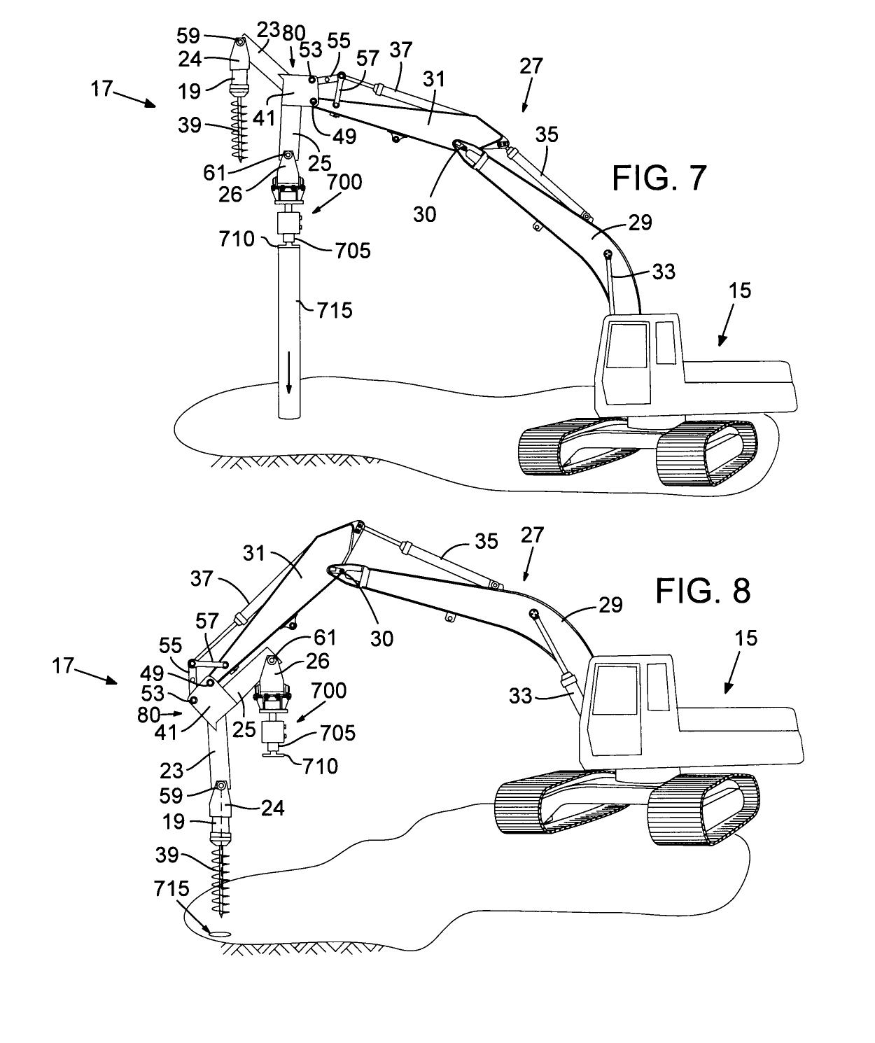

FIGS. 7 and 8 illustrate an embodiment for placing a pipe casing 715 into the ground and boring out the pipe casing 715. The tool platform 15 has a soil structure tool 17 attached as described above. The first tool arm 23 has an auger 39 attached and the second tool arm 25 has a vibratory pile driver 700 attached.

As illustrated in FIG. 7, a hydraulic clamp 705 is used to grasp a pile driving cap 710. A section of open ended pipe casing 715 is stood vertically on the ground and the tool platform 15 or the articulating arm 27 is moved, or both are moved, to place the pile driving cap 710 on the pipe casing 715. The vibratory pile driver 700 is then operated in conjunction with exerting a downward force by the tool platform 15, the articulating arm 27, or both, on the pipe casing 715 to drive the pipe casing 715 into the ground.

As illustrated in FIG. 8, when the pipe casing 715 is driven into the ground, the tool platform 15, the articulating arm 27, or both, are moved to lift the vibratory pile driver 700 and the pile driving cap 710 from the pipe casing 715. The soil structure tool 17 is moved to place the auger 39 into a working position above the pipe casing 715 and to place the vibratory pile driver 700 into a non-working position. The articulating arm 27 and the auger 39 may then be operated to bore the soil out from the interior of the pipe casing 715. The bored out pipe casing 715 may be used, for example, as a conduit to run cables, or filled with concrete to act as a structural component in the soil. In alternate embodiments (not illustrated), the soil structure tool 17 may carry an additional tool, such as the outlet hose from a concrete pump, that is placed into a working position over the pipe casing 715 while the auger 39 and vibratory pile driver 700 are placed into non-working positions. Various other tools may be attached to the first tool arm 23 and the second tool arm 25 depending on the structure being built or placed in the ground. More than two tool arms may be included, for example, a third tool arm may be included.

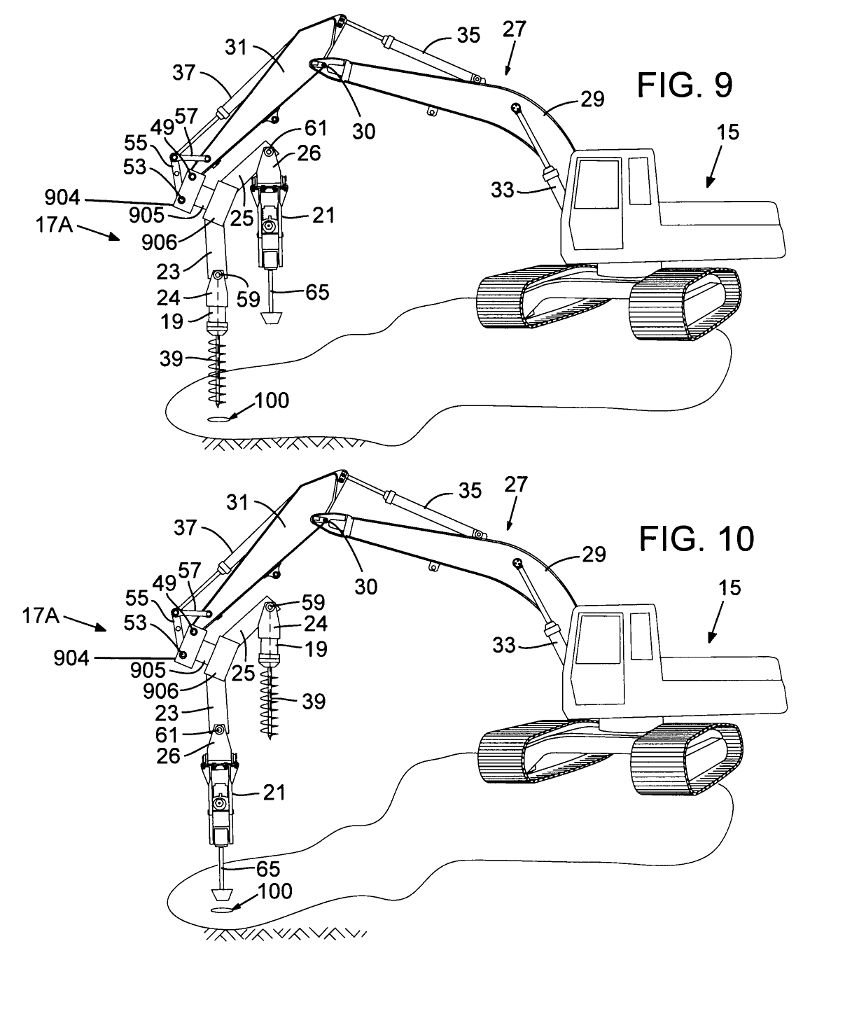

A soil structure tool may be constructed in alternate manners to allow the first device to be in a working position while holding the second device in a non-working position, and vice-versa. Referring to FIGS. 9 and 10, for example, the first tool arm 23 and the second tool arm 25 are rigidly attached to a rotatable tool head that includes a first portion 904, a rotatable portion 905, and a second portion 906. The first portion 904 preferably includes two substantially flat plates. The rotatable portion 905 preferably includes an electric, hydraulic, pneumatic, gas or other suitable motor connected to the third tool head portion 906, for example, by a spline shaft or through gears, to rotate the third tool head portion 906. The third tool head portion 906 preferably rotates about an axis of rotation extending through the first portion 904, the rotatable portion 905, and the second portion 906, and the axis of rotation may extend in a plane substantially defined by the articulating arm 27. The third tool head portion 906 preferably includes two substantially flat plates.

When the third tool head portion 906 is rotated to place the first tool arm 23 distal from the dipper arm 31, that is, to place the digging device 19 in a working position, the second tool arm 25 is placed proximate the dipper arm 31, that is, the vibratory pile driver 700 is in a non-working position. When the devices are moved between the working position and the non-working position, the articulating arm 27 may be raised to bring both the first tool arm 23 and the second tool arm 25 to approximately the same height. Bringing the first tool arm 23 and the second tool arm 25 to approximately the same height preferably balances the forces exerted on the connection between the rotatable portion 905 and the third tool head portion 906, thus making it easier to rotate the third tool head portion 906 about its axis of rotation, for example, as described above. Once the second tool arm 25 is distal from the dipper arm 31 and the first tool arm 23 is proximate the dipper arm 31, the articulating arm 27 is tilted to lower the second tool arm to be closer to the ground as depicted in FIG. 10.

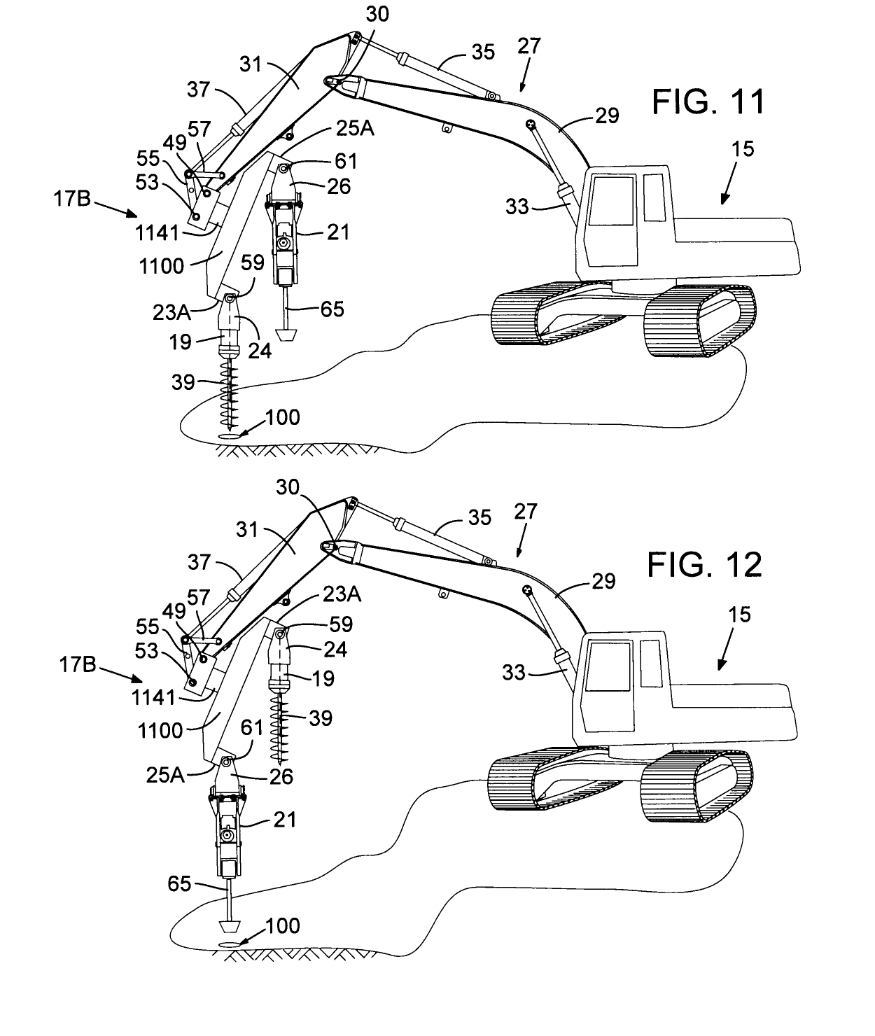

FIGS. 11 and 12 illustrate an alternate embodiment of a soil structure tool 17B. Soil structure tool 17B may have the digging device 19, or other tool, and the impacting device 21, or other tool, rotatably mounted on a stationary tool head 1141. Preferably, the first tool arm 23A and the second tool arm 25A are rotatably mounted on a stationary tool head 1141 as illustrated. A track or raceway 1100 is rigidly attached to the fixed tool head 1141 and rotatably carries the first tool arm 23A and the second tool arm 25A. The first tool arm 23A and the second tool arm 25A are preferably rotatably mounted in the raceway 1100 to travel on an oval, circular, or other path. The raceway 1100 may contain an electric motor or other actuator for moving the first tool arm 23A and the second tool arm 25A between a working position and a non-working position.

Other embodiments may use different structures or mechanisms for moving a first tool and a second tool between working and non-working positions. Yet other embodiments may provide more than two tools and move the tools so that one tool is in a working position while the remaining tools are in non-working positions.

It will be obvious to those having skill in the art that many changes may be made to the details of the above-described embodiments without departing from the underlying principles of the invention. The scope of the present invention should, therefore, be determined only by the following claims.

1. A soil structure tool comprising:
a tool head pivotally connected to an articulated arm of a tool platform, the tool head including a first elongate tool head portion and a second elongate tool head portion extending in a direction substantially away from the first elongate tool head portion;
a first device mount pivotally connected proximate a free end of the first elongate tool head portion; and
a second device mount pivotally connected proximate a free end of the second elongate tool head portion.

2. The soil structure tool according to claim 1, wherein:
the first elongate tool head portion includes a first arm rigidly connected to a tool head base; and
the second elongate tool head portion includes a second arm rigidly connected to the tool head base.

3. The soil structure tool according to claim 2, wherein:
the tool head base includes a first plate and a second plate, the first arm is rigidly attached between the first and second plates, and the second arm is rigidly attached between the first and second plates;
the first device mount includes a third plate and a fourth plate, and the third and fourth plates are pinned proximate to the free end of the first arm; and
the second device mount includes a fifth plate and a sixth plate, and the fifth and sixth plates are pinned proximate to the free end of the second arm.

4. The soil structure tool according to claim 3, further comprising:
a motor operably connected to an auger, the motor retained between the third and fourth plates; and
a pneumatic hammer operably connected to a tamping apparatus, the pneumatic hammer retained between the fifth and sixth plates.

5. The soil structure tool according to claim 2, further comprising a first selectively engagable coupling structure operably connected between the first arm and the first device mount; and a second selectively engagable coupling structure operably connected between the second arm and the second device mount.

6. The soil structure tool according to claim 5, wherein the first selectively engagable coupling structure and the second selectively engagable coupling structure each include an engagable tongue and groove.

7. The soil structure tool according to claim 2, wherein the tool head includes:
a first portion pivotally connected to an articulated arm of a tool platform;
a second portion coupled to the first portion;
a third portion rotatably coupled to the second portion, wherein the first arm is rigidly attached to the tool head third portion, and the second arm is rigidly attached to the tool head third portion.

8. The soil structure tool according to claim 7, wherein the second portion includes an actuator selected from the group of an electric motor, a pneumatic motor, and a hydraulic motor.

9. A soil structure tool comprising:
a tool head pivotally connected to an articulated arm of a tool platform;
a raceway attached to the tool head;
a first arm moveably connected in the raceway;
a first device mount pivotally connected to the first arm;
a second arm moveably connected in the raceway; and
a second device mount pivotally connected to the second arm

10. A soil structure tool according to claim 9, wherein:
the tool head includes a first plate and a second plate;
the first device mount includes a third plate and a fourth plate, and the third and fourth plates are pinned proximate to a free end of the first arm; and
the second device mount includes a fifth plate and a sixth plate, and the fifth and sixth plates are pinned proximate to a free end of the second arm

11. A soil structure tool according to claim 10, further comprising:
a motor operably connected to an auger, the motor retained between the third and fourth plates; and
a pneumatic hammer operably connected to a tamping apparatus, the pneumatic hammer retained between the fifth and sixth plates.

12. A tool for constructing structures in soil according to claim 11, further comprising:
a first selectively engagable coupling structure operably connected between the first arm and the first device mount; and
a second selectively engagable coupling structure operably connected between the second arm and the second device mount.

13. A method for improving a load bearing capability of soil comprising the steps of:
providing a soil structure tool attached to an articulating arm of a tool platform wherein the soil structure tool includes a tool head having a first elongate portion and a second elongate portion extending in a direction substantially away from the first elongate portion, a first device pivotally connected proximate a free end of the first elongate portion, and a second device pivotally connected proximate a free end of the second elongate portion;
positioning the tool platform proximate a location where the load bearing capability for soil will be improved;
operating the articulating arm to move the first device into a working position wherein the first device pivots to substantially align with a longitudinal axis of the first elongate portion, and to simultaneously move the second device into a non-working position;
operating the articulating arm and the first device to create a bore in the soil;
removing the first device from the bore;
operating the articulating arm to move the second device into a working position wherein the second device pivots to substantially align with a longitudinal axis of the second elongate portion, and to simultaneously move the first device into a non-working position; and
operating the articulating arm and the second device to build a structure in the bore.

14. The method according to claim 13, wherein:
the force of gravity substantially aligns the first device with the longitudinal axis of the first elongate portion when the articulating arm is operated to move the first device into a working position; and
the force of gravity substantially aligns the second device with the longitudinal axis of the second elongate portion when the articulating arm is operated to move the second device into a working position.

15. The method according to claim 14, further comprising:
placing aggregate in the bore after removing the first device from the bore; and
wherein building the structure includes compacting the aggregate with the second device.

16. The method according to claim 13 wherein the step of moving the first device to a working position and simultaneously moving the second device to a non-working position is accomplished by pivotal movement of the soil structure tool; and
wherein the step of moving the second device to a working position and simultaneously moving the first device to a non-working position is accomplished by pivotal movement of the soil structure tool.

17. The method according to claim 13 wherein the step of moving the first device to a working position and simultaneously moving the second device to a non-working position is accomplished by rotational movement of the soil structure tool; and
wherein the step of moving the second device to a working position and simultaneously moving the first device to a non-working position is accomplished by rotational movement of the soil structure tool.
